(19) United States
(12) Patent Application Publication
(10) Pub. No.: US 2021/0229395 A1
(43) Pub. Date: Jul. 29, 2021

(54) TRANSPARENT NET STRUCTURE

(71) Applicant: ENEOS CORPORATION, Tokyo (JP)

(72) Inventors: Tomoyuki OKAMURA, Tokyo (JP); Keiichi OOTSUBO, Sanbu-gun (JP); Masahiro WAKAYAMA, Sanbu-gun (JP)

(73) Assignee: ENEOS CORPORATION, Tokyo (JP)

(21) Appl. No.: 17/059,077

(22) PCT Filed: Apr. 23, 2019
(86) PCT No.: PCT/JP2019/017203

§ 371 Date: Nov. 25, 2020

(30) Foreign Application Priority Data
May 31, 2018 (JP) 2018-105231

(51) Int. Cl. B32B 5/02; B32B 7/12; B32B 5/24; D04H 3/045; D04H 13/02; D04H 3/007; B32B 27/12; B32B 27/32

(52) U.S. Cl. CPC B32B 5/028; D10B 2505/02; B32B 5/24; D04H 3/045; D04H 13/02; D04H 3/007; B32B 27/12; B32B 27/327; B32B 2262/0253; B32B 2307/412; B32B 2307/516; B32B 2250/02; B32B 2250/242; B32B 2439/80; B32B 2439/70; D10B 2321/022; D10B 2505/10; B32B 7/12

(57) ABSTRACT

A transparent net structure including two or more uniaxial alignment bodies of a multilayer film which includes a thermoplastic resin layer containing at least one polypropylene (T) selected from the group consisting of block polypropylene and random polypropylene polymerized with a metallocene catalyst, and an adhesive layer containing polypropylene (A) polymerized with a metallocene catalyst and laminated on at least one surface of the thermoplastic resin layer, in which the two or more uniaxial alignment bodies are laminated or woven such that the adhesive layers are interposed among the two or more uniaxial alignment bodies and alignment axes of the two or more uniaxial alignment bodies intersect with each other.

### TECHNICAL FIELD

The present invention relates to a transparent net structure.

Priority is claimed on Japanese Patent Application No. 2018-105231, filed May 31, 2018, the content of which is incorporated herein by reference.

### BACKGROUND ART

In the related art, a multilayer film obtained by laminating low-density polyethylene, produced by a high-pressure radical polymerization method, on both sides of high-density polyethylene, is stretched, a split net film is laminated thereon such that the alignment axes intersect with each other, and a thermocompression-bonded polyethylene nonwoven fabric or a woven fabric formed by weaving stretched tape that is obtained by cutting the multilayer film before or after being stretching has been developed. Such nonwoven fabrics or woven fabrics are used for vegetable bags for over-the-counter sales, various bags, and reinforcing bags, tapes, and the like which are obtained by compounding agricultural covering materials, agricultural materials, and other materials.

Patent Literatures 1 and 2 each describe a method of producing a net nonwoven fabric obtained by laminating a uniaxial alignment body (vertical web) made of a thermoplastic resin which is aligned in a longitudinal direction (length direction) and a uniaxial alignment body (horizontal web) made of a thermoplastic resin which is aligned in a lateral direction (width direction). This net nonwoven fabric is produced by pressing and heating the vertical web and the horizontal web, which are separately formed, in a state of being overlapped with each other, and thus the vertical web and the horizontal web are integrated with each other.

Such net nonwoven fabrics are thin, lightweight, have satisfactory air permeability and high strength in both the longitudinal and lateral directions, and are well-balanced and highly firm. It also has excellent properties in terms of water resistance and chemical resistance.

### CITATION LIST

### Patent Literature

### [PTL 1]

Japanese Unexamined Patent Application, First Publication No. Hei 4-82953

### [PTL 2]

Japanese Unexamined Patent Application, First Publication No. Hei 8-267636

### SUMMARY OF INVENTION

### Technical Problem

In food filters, the contents therein are required to be visible in some cases. Therefore, in a case where the net nonwoven fabrics are used as reinforcing materials for food filters, the net nonwoven fabrics are required to have high transparency.

The present invention has been made in consideration of the above-described circumstances, and an object thereof is to provide a net nonwoven fabric having a high transparency.

### Solution to Problem

According to a first aspect of the present invention, there is provided a transparent net structure including two or more uniaxial alignment bodies of a multilayer film which includes a thermoplastic resin layer containing at least one polypropylene (T) selected from the group consisting of block polypropylene and random polypropylene polymerized with a metallocene catalyst, and an adhesive layer containing polypropylene (A) polymerized with a metallocene catalyst and laminated on at least one surface of the thermoplastic resin layer, in which the two or more uniaxial alignment bodies are laminated or woven such that the adhesive layers are interposed among the two or more uniaxial alignment bodies and alignment axes of the two or more uniaxial alignment bodies intersect with each other.

### Advantageous Effects of Invention

According to the present invention, a net nonwoven fabric having a high transparency can be provided.

### BRIEF DESCRIPTION OF DRAWINGS

FIG. 1 is a plan view showing a first transparent net structure according to an embodiment of the present invention.

FIG. 2 is a perspective view showing a configuration example of a uniaxial alignment body constituting the transparent net structure shown in FIG. 1.

FIG. 3 is a perspective view showing a configuration example of the uniaxial alignment body constituting the transparent net structure shown in FIG. 1.

FIG. 4 is a perspective view showing a method of producing the uniaxial alignment body shown in FIG. 2.

FIG. 5 is a perspective view showing a first method of producing a net nonwoven fabric according to an embodiment of the present invention.

FIG. 6 is a plan view showing a second transparent net structure according to an embodiment of the present invention.

FIG. 7 is a perspective view showing a second method of producing a net nonwoven fabric according to an embodiment of the present invention.

FIG. 8 is a plan view showing a third transparent net structure according to an embodiment of the present invention.

FIG. 9 is a plan view showing a third transparent net structure according to an embodiment of the present invention.

### DESCRIPTION OF EMBODIMENTS

### First Embodiment: Transparent Net Structure

The transparent net structure according to the first embodiment of the present invention is a transparent net structure including two or more uniaxial alignment bodies of a multilayer film which includes a thermoplastic resin layer and an adhesive layer containing polypropylene polymerized with a metallocene catalyst and laminated on at least one surface of the thermoplastic resin layer, in which the two or more uniaxial alignment bodies are laminated or woven such that the adhesive layers are interposed among the two or more uniaxial alignment bodies and alignment axes of the two or more uniaxial alignment bodies intersect with each other.

First, the layer configuration of the uniaxial alignment body and the composition of each layer constituting the transparent net structure according to the present embodiment will be described. The uniaxial alignment body is obtained by uniaxially aligning a uniaxially oriented multilayer film including a thermoplastic resin layer and an adhesive layer laminated on at least one surface of the thermoplastic resin layer.

The thermoplastic resin layer is a layer containing a thermoplastic resin as a main component. The thermoplastic resin is at least one polypropylene (T) selected from the group consisting of block polypropylene and random polypropylene polymerized with a metallocene catalyst (hereinafter, also referred to as “metallocene catalyst-based random polypropylene”). From the viewpoint of enhancing the transparency of the transparent net structure, it is preferable that the polypropylene (T) is block polypropylene or metallocene catalyst-based random polypropylene.

The thickness of the thermoplastic resin layer is not particularly limited, and can be appropriately determined by those skilled in the art so as to achieve a predetermined basis weight in a case where the thickness of the adhesive layer is set to be in a desired range described below. The thickness of the thermoplastic resin layer is preferably in a range of 10 to 70 μm and more preferably in a range of 10 to 30 μm. Further, the thickness is the layer thickness after uniaxial alignment.

The adhesive layer is a layer containing polypropylene (A) polymerized with a metallocene catalyst, as a main component.

It is preferable that the melt flow rate of polypropylene (A) is higher than the melt flow rate of polypropylene (T). In a case where the melt flow rate of polypropylene (A) is higher than the melt flow rate of polypropylene (T), the uniaxial alignment body can be satisfactorily formed into a film, and thus failure such as deterioration of the surface of the uniaxial alignment body is unlikely to occur.

Specifically, the melt flow rate of polypropylene (A) is preferably in a range of 0.5 to 20 g/10 min and more preferably in a range of 1 to 10 g/10 min.

Further, from the viewpoint of production, the melting point of polypropylene (A) is preferably lower than the melting point of polypropylene (T) by 5° C. or higher and more preferably lower than the melting point of the polypropylene (T) by 10° to 50° C. In a case where the melting point of polypropylene (A) is lower than the melting point of polypropylene (T) by 5° C. or higher, a transparent net structure having desired physical properties can be produced.

The polypropylene contained in the adhesive layer is polymerized with a metallocene catalyst (hereinafter, also referred to as “metallocene catalyst-based polypropylene”). The metallocene catalyst is a so-called single-site catalyst having a relatively single active site and contains at least a transition metal compound of Group IV in the periodic table which includes a ligand having a cyclopentadienyl skeleton. Typical examples thereof include metallocene complexes of transition metals, such as catalysts obtained by reacting biscyclopentadienyl complexes of zirconium and titanium with methyl aluminoxane as a co-catalyst. Further, these catalysts are homogeneous or heterogeneous catalysts obtained by variously combining various complexes, co-catalysts, and carriers. Examples of the metallocene catalyst include known catalysts described in Japanese Unexamined Patent Application, First Publication Nos. S58-19309, S59-95292, S59-23011, S60-35006, S60-35007, S60-35008, S60-35009, S61-130314, and H3-163088.

The polypropylene contained in the adhesive layer or the random polypropylene contained in the thermoplastic resin layer can be obtained by copolymerizing propylene and α-olefin according to a production process such as a gas phase polymerization method, a slurry polymerization method, or a solution polymerization method in the presence of such a metallocene catalyst. In the copolymer, it is preferable to use α-olefin having 4 to 12 carbon atoms. Specific examples thereof include butene, pentene, hexene, peptene, octene, nonene, and decene.

In the present invention, from the viewpoint of improving the transparency of the transparent net structure, it is preferable that the adhesive layer contains random polypropylene polymerized with a metallocene catalyst.

The thickness of the adhesive layer is in a range of 2 to 10 μm, preferably in a range of 2 to 9 μm, and more preferably in a range of 2 to 7 μm. In a case where the thickness thereof is less than 2 μm, a satisfactory adhesive force cannot be obtained. Meanwhile, in a case where the thickness thereof is greater than 10 μm, the tensile strength is lowered. Therefore, the structure becomes soft, and thus the effect as a reinforcing material cannot be sufficiently obtained. Further, the thickness is the layer thickness after uniaxial alignment.

In the transparent net structure of the present invention, the haze of the multilayer film which is measured in conformity with JIS K7136 is preferably less than 8% and more preferably less than 6%. In a case where the haze of the multilayer film is less than 8%, the transparency of the transparent net structure becomes satisfactory.

Further, in the multilayer film, the haze of the thermoplastic resin layer which is measured in conformity with JIS K7136 is preferably 40% or less and more preferably 30% or less.

In the multilayer film, in a case where the haze of the thermoplastic resin layer is set to be in the above-described, the haze of the multilayer film is likely to be less than 8%.

The resins constituting each of the thermoplastic resin layer and the adhesive layer may include resins other than the above-described main components such as polypropylene and polyethylene or known additives within a range that does not impair the characteristics thereof. Examples of the additives include an antioxidant, a weathering agent, a lubricant, an antiblocking agent, an antistatic agent, an antifogging agent, a drip-proof agent, a pigment, and a filler.

The uniaxial alignment body is obtained by uniaxially aligning the multilayer film having such a composition and such a layer configuration. The uniaxial alignment body may be, for example, a uniaxial alignment net film or a uniaxial alignment tape. The detailed aspects and production methods will be described below. The transparent net structure according to the present invention is formed by laminating or weaving at least two uniaxial alignment bodies, and the at least two uniaxial alignment bodies are laminated or woven such that the alignment axes intersect with each other. Here, the two uniaxial alignment bodies may have the same composition and the same layer configuration or may have different compositions and different layer configurations. The transparent net structure may be a net nonwoven fabric or a woven fabric depending on the characteristics of the uniaxial alignment body. Further, the alignment axes may intersect at a substantially right angle or may intersect at a predetermined angle. In a case where three or more uniaxial alignment bodies are laminated, the alignment axes of the three or more alignment bodies may intersect at a predetermined angle. Hereinafter, embodiments of the transparent net structure according to the form of the uniaxial alignment bodies and the combination thereof will be described.

### First Transparent Net Structure: Nonwoven Fabric Obtained by Laminating Split Web and Slit Web

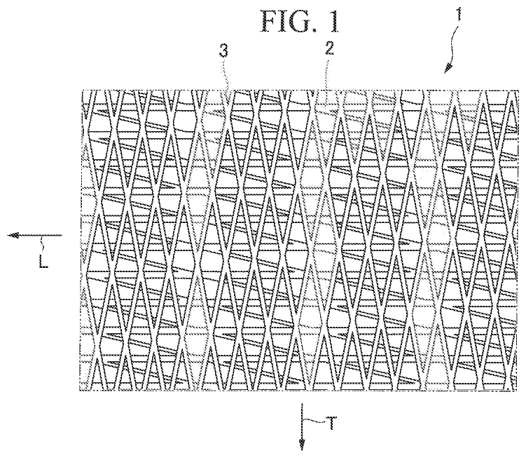

A first transparent net structure is a nonwoven fabric formed by laminating a uniaxial alignment body obtained by splitting a uniaxially stretched multilayer film in the longitudinal direction and widening the film and a uniaxial alignment body obtained by forming slits in a multilayer film in the width direction and uniaxially stretching the film in the width direction, such that the alignment directions thereof are substantially orthogonal to each other. FIG. 1 shows a net nonwoven fabric which is an example of the transparent net structure according to an embodiment of the present invention. A net nonwoven fabric 1 is formed by laminating a split web 2 which is an example of the uniaxial alignment body and a slit web 3 which is another example of the uniaxial alignment body such that an alignment axis L of the split web 2 and the alignment axis T of the slit web 3 intersect with each other in the warp and weft directions. Further, the contact portions of the split webs 2 and slit webs 3 adjacent to each other are joined by face bonding.

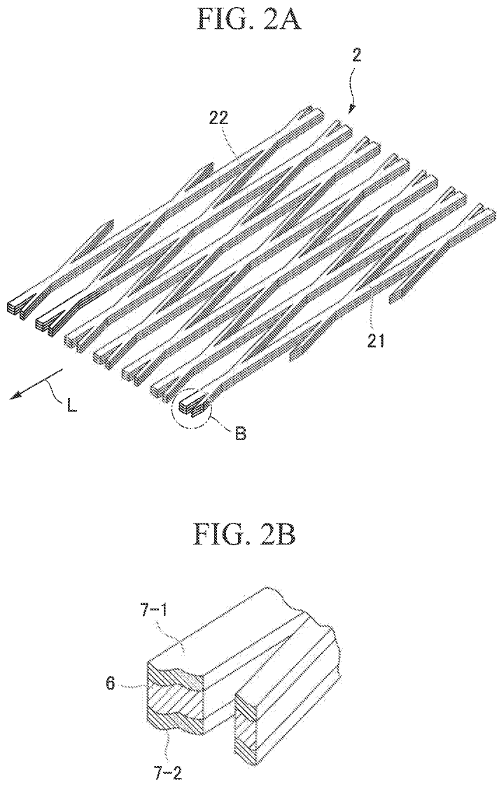

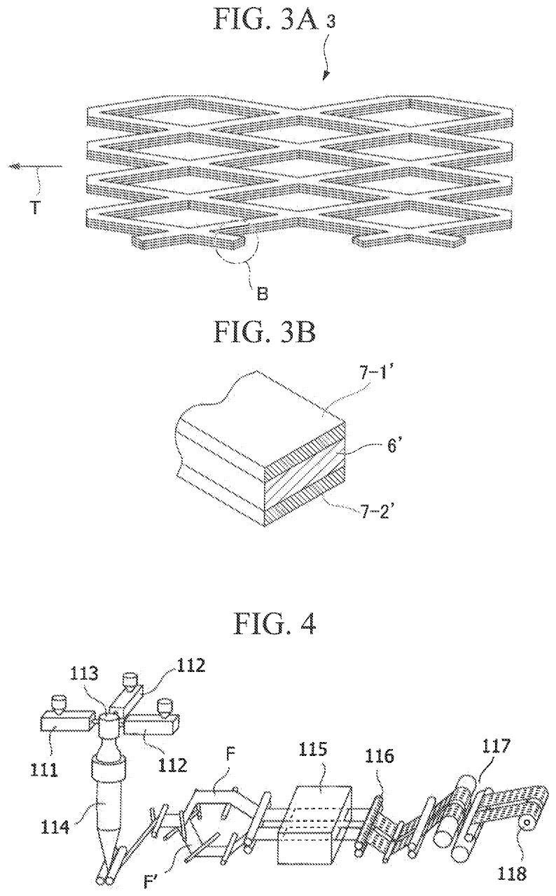

FIGS. 2 and 3 respectively show the split web 2 and the slit web 3 which constitute the net nonwoven fabric 1 shown in FIG. 1. The split web 2 shown in FIG. 2(A) is a uniaxial alignment net film formed by uniaxially stretching the multilayer film, which is obtained by laminating the adhesive layer on one or both surfaces of the thermoplastic resin layer, in the longitudinal direction (the axial direction of the alignment axis L of the split web 2), splitting the film in the longitudinal direction, and widening the film.

The split web 2, which is an example of the uniaxial alignment body formed of a net film, can be produced by a production method such as a multilayer inflation molding method or a multilayer T-die method. Specifically, a multilayer film obtained by laminating an adhesive layer containing metallocene catalyst-based polypropylene on both surfaces of a thermoplastic resin layer is formed. In the following specification, the adhesive layer containing metallocene catalyst-based polypropylene is also referred to as a metallocene PP layer. The split web is formed by stretching the multilayer film at least 3 times the initial size in the longitudinal direction, splitting the film (split treatment) in a zigzag manner in the same direction using a splitter to form a net film, and further widening the film to have a predetermined width. By widening the film, stem fibers 21 and branch fibers 22 are formed, thereby obtaining a net body as shown in the figure. The split web 2 has a relatively high strength in the longitudinal direction over the entire width direction.

FIG. 2(B) is an enlarged perspective view of a region B surrounded by a dashed line in FIG. 2(A), and the split web 2 has a three-layer structure in which metallocene PP layers 7-1 and 7-2 each having a lower melting point than that of the thermoplastic resin 6 are laminated on both surfaces of the thermoplastic resin layer 6. One of the metallocene PP layers 7-1 and 7-2 functions as an adhesive layer between the webs to be laminated with the slit web 3 in the warp and weft directions in a case of forming the net nonwoven fabric 1.

The slit web 3 shown in FIG. 3(A) is a net film formed by forming multiple slits in the multilayer film in which the metallocene PP layers are laminated on both surfaces of the thermoplastic resin layer in the lateral direction (the axial direction of the alignment axis T of the slit web 3) and uniaxially stretching the film in the lateral direction. Specifically, the slit web 3 is formed by forming intermittent slits parallel to each other in a zigzag manner or the like using a hot blade or the like in the lateral direction (width direction) in a portion excluding both ear portions of the multilayer film and stretching the film in the lateral direction. The slit web 3 has a relatively high strength in the lateral direction.

FIG. 3(B) is an enlarged perspective view of the region B surrounded by a dashed line in FIG. 3(A), and the slit web 3 has a three-layer structure in which metallocene PP layers 7-1′ and 7-2′ each having a lower melting point than that of the thermoplastic resin are laminated on both surfaces of a thermoplastic resin layer 6′. One of the metallocene PP layers 7-1′ and 7-2′ functions as an adhesive layer between the webs to be laminated with the split web 2 in the warp and weft directions in a case of forming the net nonwoven fabric 1.

As the shape of the slit web, in addition to the shape shown in FIG. 3, a slit web, which is a uniaxial alignment body including stem fibers extending in parallel with each other and branch fibers connecting adjacent stem fibers and obtained by alignment of the stem fibers substantially in one direction and which is obtained by forming multiple slits in a raw film having the same configuration as the configuration of the split web 2 in the width direction and stretching the film at the same stretch ratio as that of the split web 2 in the width direction, that is, the slit web which has a pattern rotating with respect to the split web 2 by ±90° or a pattern similar to this pattern can be used as a uniaxial alignment net film.

The three-layer structure of the uniaxial alignment body shown in FIGS. 2 and 3 is an example. For example, the metallocene PP layer 7-1 in the split web 2 can be omitted, and the uniaxial alignment body may have a two-layer structure of the thermoplastic resin layer 6 and the metallocene PP layer 7-2. Further, the metallocene PP layer 7-1′ in the slit web 3 can be omitted, and the uniaxial alignment body may have a two-layer structure of the thermoplastic resin layer 6′ and the metallocene PP layer 7-2′. Therefore, the net nonwoven fabric may be any combination of these split web and slit web having two- or three-layer structure.

The basis weight of the net nonwoven fabric 1 according to the present embodiment is preferably in a range of 5 to 70 g/m², more preferably in a range of 5 to 60 g/m², and still more preferably in a range of 5 to 50 g/m². The basis weight thereof can be controlled by changing the thickness of the thermoplastic resin layer 6. Further, the tensile strength of the net nonwoven fabric according to the present embodiment is preferably in a range of 20 to 600 N/50 mm, more preferably in a range of 20 to 500 N/50 mm, and still more preferably in a range of 20 to 400 N/50 mm.

The tensile strength thereof can be controlled by changing the thickness of the thermoplastic resin layer 6. The tensile strength according to the present embodiment indicates the tensile strength in the longitudinal direction.

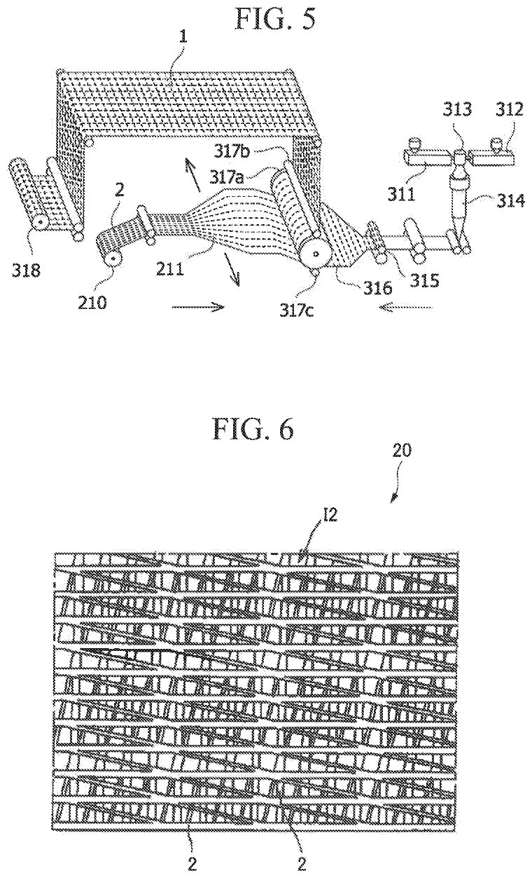

Next, the method of producing the net nonwoven fabric 1 shown in FIG. 1 will be described with reference to FIGS. 4 and 5.

FIG. 4 schematically shows a step of producing the split web 2. Further, FIG. 5 schematically shows a step of producing the net nonwoven fabric 1 by laminating the slit web 3 on the split web 2.

In (1) step of forming the multilayer film in FIG. 4, a thermoplastic resin is supplied to a main extruder 111, and a metallocene catalyst-based polypropylene resin is supplied to two sub-extruders 112 as an adhesive layer resin to prepare a multilayer film through inflation molding using the thermoplastic resin extruded from the main extruder 111 as a central layer and using the adhesive layer resins extruded from the two sub-extruders 112 and 112 as an inner layer and an outer layer. Here, the thermoplastic resin constitutes the layer 6 formed of the thermoplastic resin shown in FIG. 2, and the metallocene catalyst-based polypropylene resin constitutes the adhesive layers 7-1 and 7-2 shown in FIG. 2. FIG. 4 shows an example of a case where a film is formed using three extruders by downward blowing water-cooled inflation 114 through a multilayer annular die 113. Further, the method of producing a multilayer film is not particularly limited, and examples thereof include a multilayer inflation method and a multilayer T-die method.

In (2) alignment step, the formed annular multilayer film described above is cut into two films F and F′, and the two films are allowed to pass through an oven 115 equipped with an infrared heater, a hot air blower, and the like, and can be subjected to roll alignment at an alignment magnification of 3 to 15 times, preferably 5 to 12 times, and more preferably 6 to 10 times the initial dimension using a cooling roller which has been subjected to a mirror surface treatment while being heated to a predetermined temperature. In a case where the stretch ratio thereof is less than 3 times, the mechanical strength may not be sufficient. Meanwhile, in a case where the stretch ratio thereof is greater than 15 times, the film is unlikely to be stretched using a known method of the related art and thus an expensive device may be require, which is problematic. It is preferable that the stretching is performed in multiple stages in order to prevent uneven stretching. The alignment temperature is lower than or equal to the melting point of the thermoplastic resin of the central layer and is typically in a range of 20° C. to 160° C., preferably in a range of 60° C. to 150° C., and more preferably in a range of 90° C. to 140° C. In addition, it is preferable that the alignment is performed in multiple stages.

In (3) split (splitting) step, the aligned multilayer film is brought into sliding contact with a splitter (rotary blade) 116 that rotates at a high speed, and the film is subjected to a split treatment (splitting). As the split method, in addition to the method described above, a mechanical method such as a method of beating a uniaxially aligned multilayer film, a method of twisting the film, a method of sliding and rubbing (causing friction) the film, or a method of brushing the film; or a method of forming countless fine cuts in the film using an air jet method, an ultrasonic method, or a laser method may be used. Among these, a rotary mechanical method is particularly preferable. Examples of such a rotary mechanical method include methods using various types of splitters such as a tap screw type splitter, a file-shaped rough surface splitter, and a needle roll-shaped splitter. For example, as the tap screw type splitter, a pentagonal or hexagonal splitter having 10 to 150 screw threads and preferably 15 to 100 screw threads per inch is typically used. As the file-shaped rough surface splitter, those described in Japanese Examined Utility Model Application, Second Publication No. S51-38980 are suitably used. The file-shaped rough surface splitter is a splitter in which a surface of a circular cross-section axis is processed into a round file for ironwork or a rough surface similar thereto and two spiral grooves are provided at an equal pitch on the surface thereof. Specific examples thereof include those disclosed in U.S. Pat. Nos. 3,662,935 and 3,693,851. The method of producing the split web 2 is not particularly limited, and preferred examples thereof include a method of disposing a splitter between nip rolls, moving a uniaxially aligned multilayer film while applying tension thereto, and bringing the film into sliding contact with the splitter rotating at a high speed so that the film is split and netted.

The moving speed of the film in the split step is typically in a range of 1 to 1000 m/min and preferably in a range of 10 to 500 m/min. Further, the rotational speed (peripheral speed) of the splitter can be appropriately selected depending on the physical properties and the moving speed of the film, the desired properties of the split web 2, and the like, but is typically in a range of 10 to 5000 m/min and preferably in a range of 50 to 3000 m/min.

The film formed by being split in the above-described manner is widened as desired, subjected to a heat treatment 117, wound at a predetermined length in (4) winding step 118, and is supplied as the split web 2 which is one uniaxial alignment body of a raw fabric for the net nonwoven fabric 1.

FIG. 5 is a schematic view showing a method of producing the net nonwoven fabric 1 according to one embodiment of the present application, and FIG. 5 shows a production method including a step of laminating the slit web 3 and the split web 2 which is a wound body in FIG. 4. As shown in FIG. 5, the production method mainly includes (1) film forming step of forming a multilayer film which is a raw fabric of the slit web 3, (2) slit step of performing a slit treatment on the multilayer film at a substantially right angle with respect to the length direction of the film, (3) uniaxial alignment step of uniaxially aligning the multilayer slit film, and (4) compression-bonding step of laminating the split web 2 on the slit web 3 obtained by uniaxial alignment and performing thermocompression bonding thereon.

Each step will be described below. In FIG. 5, in (1) step of forming a multilayer film, a thermoplastic resin is supplied to the main extruder 311, a metallocene catalyst-based polypropylene is supplied to the sub-extruder 312, and a two-layer film is prepared through inflation molding using the thermoplastic resin extruded from the main extruder 311 as an inner layer and the metallocene catalyst-based polypropylene extruded from the sub-extruder 312 as an outer layer. Here, the thermoplastic resin constitutes the thermoplastic resin layer 6′ shown in FIG. 3 and the metallocene catalyst-based polypropylene constitutes the adhesive layers 7-1′ and 7-2′ shown in FIG. 3. FIG. 5 shows an example of a case where a film is formed using two extruders by downward blowing water-cooled inflation 314 through the multilayer annular die 313. The method of producing a multilayer film is not particularly limited, a multilayer inflation method or a multilayer T-die method in the same manner as in the example of FIG. 4.

In (2) slit step, the formed multilayer film is pinched to be flattened and finely aligned by rolling, and transverse slits 315 are formed in the film in a zigzag manner at a substantially right angle with respect to the traveling direction. Examples of the slit method include a method of cutting the film with a sharp edge such as a razor blade or a high-speed rotary blade and a method of forming slits with a score cutter, a shear cutter, or the like. Particularly, a slit method carried out using a hot blade (heat cutter) is most preferable. Examples of such hot blades are disclosed in Japanese Examined Patent Application, Second Publication No. S61-11757, U.S. Pat. Nos. 4,489,630, and 2,728,950.

In (3) alignment step, the uniaxial alignment 316 is performed on the multilayer film which has been subjected to the slit treatment in the width direction. Examples of the alignment method include a tenter method and a pulley method, but the pulley method is preferable because the device is small and thus economical. Examples of the pulley method include the methods disclosed in British Patent No. 849436 and Japanese Examined Patent Application, Second Publication No. S57-30368. The conditions such as the alignment temperature are the same as in the case of the example shown in FIG. 4.

The slit web 3 (horizontal web) which is the uniaxial alignment body obtained in the above-described manner is conveyed to (4) thermocompression-bonding step 317. Meanwhile, the split web 2 (vertical web) which is the uniaxial alignment body produced by the method shown in FIG. 4 is pulled out of a raw fabric pull-out roll 210, allowed to travel at a predetermined supply rate to be sent to a widening step 211, widened several times the initial size by the above-described widening machine, and subjected to a heat treatment as necessary.

The vertical web is laminated on the above-described horizontal web and sent to the thermocompression-bonding step 317, and the vertical web and the horizontal web are laminated such that the alignment axes intersect with each other and then thermocompression-bonded. Specifically, the vertical web 2 and the horizontal web 3 are sequentially guided between a thermal cylinder 317a having an outer peripheral surface that is a mirror surface and mirror surface rolls 317b and 317c, and a nip pressure is applied thereto for thermocompression bonding so that these are integrated with each other.

In this manner, the contact portions between the vertical web 2 and the horizontal web 3 adjacent to each other are entirely face-bonded to each other.

The resultant is allowed to pass through a defect inspection such as stitch skipping and conveyed to a winding step 318, thereby obtaining a wound body (product) of the net nonwoven fabric 1.

### Second Transparent Net Structure: Nonwoven Fabric Obtained by Laminating Split Webs in Warp and Weft Directions

The second transparent net structure is a net nonwoven fabric formed by laminating uniaxial alignment bodies, obtained by splitting a uniaxially stretched multilayer film in the longitudinal direction and widening the film, in the warp and weft directions such that the alignment directions intersect with each other and are preferably substantially orthogonal to each other. That is, as shown in FIG. 6, in the second transparent net structure 20, both the uniaxial alignment bodies to be laminated are net nonwoven fabrics formed of a net base material 12, which are obtained by laminating and bonding the split webs 2 described in the section of the first transparent net structure such that the stretching directions are substantially orthogonal to each other.

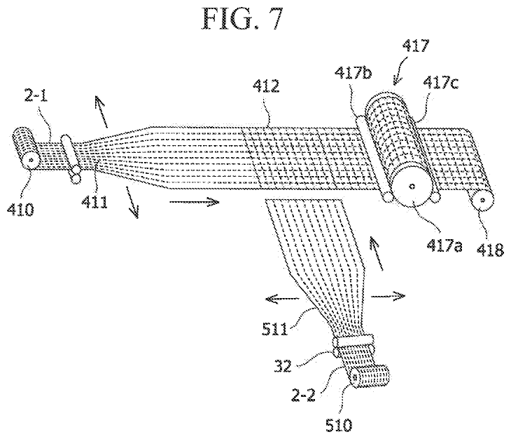

FIG. 7 is a conceptual view for describing the method of producing the nonwoven fabric which is the second transparent net structure. The net nonwoven fabric is obtained by laminating two split webs 2 shown in FIG. 2 in the warp and weft directions. In FIG. 7, a split web 2-1 (vertical web) produced as shown in FIG. 4 is pulled out of a raw fabric pull-out roll 410, allowed to travel at a predetermined supply rate to be sent to a widening step 411, widened several times the initial size by a widening machine (not shown), and subjected to a heat treatment as necessary.

Another split web 2-2 (horizontal web) is pulled out of a raw fabric pull-out roll 510 similar to the vertical web, allowed to travel at a predetermined supply rate to be sent to a widening step 511, widened several times the initial size by a widening machine (not shown), subjected to a heat treatment as necessary, cut into a length equal to the width of the vertical web 2-1, supplied from a direction perpendicular to the traveling film of the vertical web 2-1, and laminated through each adhesive layer in the warp and weft directions such that the alignment axes of the webs are orthogonal to each other in a lamination step 412. In a thermocompression-bonding step 417, the vertical web 2-1 and the horizontal web 2-2 that have been laminated in the warp and weft directions are sequentially guided between a thermal cylinder 417a having an outer peripheral surface that is a mirror surface and mirror surface rolls 417b and 417c, and a nip pressure is applied thereto. In this manner, the vertical web 2-1 and the horizontal web 2-2 are thermocompression-bonded to each other so as to be integrated with each other.

Further, the contact portions between the vertical web 2-1 and the horizontal web 2-2 adjacent to each other are entirely face-bonded to each other. The vertical web 2-1 and the horizontal web 2-2 which have been integrated with each other in the above-described manner are wound up in a winding step 418 to form a winding body of the net nonwoven fabric laminated in the warp and weft directions.

The second transparent net structure produced in the above-described manner also has the same numerical characteristics as those of the first transparent net structure in terms of the basis weight, the tensile strength in both the longitudinal and lateral directions, the thickness of the adhesive layer, and the adhesive force, and exhibits the same effects as those of the first transparent net structure.

### Third Transparent Net Structure: Net Nonwoven Fabric and Woven Fabric Formed of Uniaxial Alignment Tape

The third transparent net structure is a nonwoven fabric obtained by laminating uniaxial alignment tape in the warp and weft directions or a woven fabric obtained by weaving the tape. That is, in the third transparent net structure, two uniaxial alignment bodies are both formed of a plurality of uniaxial alignment tape groups. Further, in a case of the nonwoven fabric, a plurality of uniaxial alignment tape groups are laminated in the warp and weft directions such that the stretching directions thereof are substantially orthogonal to each other and welded or bonded. In a case of the woven fabric, a plurality of uniaxial alignment tape groups are woven in an arbitrary manner such that the groups are warp yarns and weft yarns and then welded or bonded.

Similar to the split web 2 described in the section of the first transparent net structure, the uniaxial alignment tape can be produced by producing a raw film having a two-layer or three-layer structure through extrusion molding such as a multilayer inflation method or a multilayer T die method, uniaxially stretching the film 3 to 15 times and preferably 3 to 10 times the initial size in the longitudinal direction, and cutting the film in a width of 2 mm to 7 mm along the stretching direction. Alternatively, similarly, the uniaxial alignment tape can be produced by producing a raw film having a two-layer or three-layer structure, cut the film in the same width along the machine direction, and uniaxially stretching the film 3 to 15 times and preferably 3 to 10 times the initial size in the longitudinal direction. In such a uniaxial alignment tape, the stretching direction (alignment direction) coincides with the longitudinal direction of the tape.

FIG. 8 shows an example of a net structure formed of a nonwoven fabric. In the transparent net structure 30 formed of a nonwoven fabric obtained by laminating such uniaxial alignment tapes, a plurality of uniaxial alignment tapes 302 (uniaxial alignment tape groups 302) corresponding to warp yarns are arranged in parallel at constant intervals, and this corresponds to one uniaxial alignment body. Meanwhile, the other uniaxial alignment body is obtained by arranging a plurality of other uniaxial alignment tapes 303 (uniaxial alignment tape group 303) corresponding to weft yarns in parallel at constant intervals and laminating the tapes on the uniaxial alignment tape groups. The warp yarns and weft yarns here are used to define the relative relationship therebetween, and the warp and weft can be used interchangeably.

At this time, the uniaxial alignment tape groups 302 and the uniaxial alignment tape groups 303 are laminated such that the longitudinal directions, that is, the alignment directions thereof are substantially orthogonal to each other. Further, the contact surfaces between the warp yarns and the weft yarns are heat-welded to form a net nonwoven fabric which is a third transparent net structure. In this case, the heat welding or the bonding are carried out in the same manners as those for the first transparent net structure. In addition, in a case where the uniaxial alignment tape is formed of two layers which are a thermoplastic resin layer and an adhesive layer, the lamination is made such that the adhesive layers of the warp yarns and the weft yarns are in contact with each other. The uniaxial alignment tape corresponding to the warp yarns and the uniaxial alignment tape corresponding to the weft yarns may be the same as or different from each other in terms of the composition, the thickness, the width, and the distance between tapes as long as the conditions such as the composition and layer thickness of the uniaxial alignment body of the present invention are satisfied.

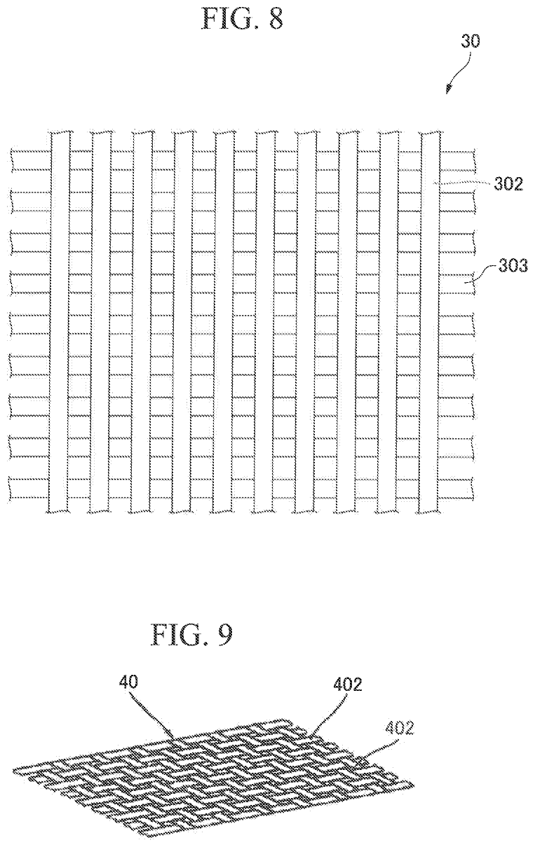

FIG. 9 shows an example of a woven fabric obtained by weaving a uniaxial alignment tape. A woven fabric 40 can be produced in the same manner as described above except that a plurality of uniaxial alignment tapes 402 are woven instead of being laminated.

The third transparent net structure also has the same characteristics as those of the first transparent net structure in terms of the basis weight, the tensile strength, the thickness of the adhesive layer, and the adhesive force between the uniaxial alignment bodies, and exhibits the same effects as those of the first transparent net structure. In the present embodiment, the adhesive force between the uniaxial alignment bodies indicates the adhesive force between the uniaxial alignment tape groups corresponding to the warp yarns and the uniaxial alignment tape groups corresponding to the weft yarns, and this value is within the range described in the section of the first transparent net structure. The tensile strength indicates the tensile strength in at least one of the alignment direction of the uniaxial alignment tape corresponding to the warp yarns or the direction of the uniaxial alignment tape corresponding to the weft yarns or the tensile strength in both directions.

### Fourth Transparent Net Structure: Net Nonwoven Fabric of Split Web and Uniaxial Alignment Tape

A fourth transparent net structure is a nonwoven fabric formed by laminating a uniaxial alignment tape group layer and a uniaxial alignment body including stem fibers extending in parallel with each other and branch fibers connecting adjacent stem fibers.

In the description of the fourth transparent net structure, a form in which three layers of uniaxial alignment bodies are laminated will be described. That is, in the fourth transparent net structure of the present invention, typically, the first uniaxial alignment body is the split web 2 and the second uniaxial alignment body is formed of a plurality of uniaxial alignment tape groups, and the fourth transparent net structure includes the third uniaxial alignment body formed of a plurality of uniaxial alignment tape groups which are obliquely intersecting the uniaxially alignment tape groups constituting the second uniaxial alignment body.

Such a transparent net structure is a nonwoven fabric obtained by laminating the split web including stem fibers extending in parallel with each other and branch fibers connecting adjacent stem fibers to each other, the first uniaxial alignment tape group layer obliquely intersecting with the alignment direction of the split web and formed of the uniaxial alignment tape groups extending in parallel with each other, and a second uniaxial alignment tape group layer obliquely intersecting with the alignment direction of the split web from a direction opposite to the first uniaxial alignment tape group layer and formed of the second uniaxial alignment tape group extending in parallel with each other. In the fourth transparent net structure, uniaxial alignment tapes are laminated on the split web at an angle of a′ with respect to the alignment direction thereof. Further, uniaxial alignment tapes obliquely intersecting with uniaxial alignment tapes are laminated at an angle α with respect to an alignment direction L. In this case, a and a′ may be the same as or different from each other and may be, for example, in a range of 45 to 60 degrees.

The split web constituting the fourth transparent net structure and the method of producing the uniaxial alignment tape are as described in the sections of the first and third transparent net structures, and the split web and the uniaxial alignment tape can be produced in the same manner as described above. The fourth transparent net structure can be obtained by laminating these and welding or bonding the contact portions.

As the uniaxial alignment body other than the uniaxial alignment tape in the fourth transparent net structure, in addition to the split web described above, a slit web which is obtained by forming multiple slits in a raw film having the same configuration as the configuration of the split web in the width direction and stretching the film at the same stretch ratio as that of the split web in the width direction, that is, the slit web which has a pattern rotating with respect to the split web by ±90° or a pattern similar to this pattern can be used. Even in this case, the slit web, the first uniaxial alignment tape group layer, and the second uniaxial alignment tape group layer can be laminated in the same manner as described above, which obliquely intersect with each other with respect to the alignment direction. Alternatively, a transparent net structure in which two layers of the split web 2b or the slit web and the first uniaxial alignment tape group layer are laminated such that the alignment direction of the split web 2b or the slit web and the longitudinal direction of the uniaxial alignment tape group intersect with each other may be employed.

The fourth transparent net structure also has the same characteristics as those of the first transparent net structure in terms of the basis weight, the tensile strength, the thickness of the adhesive layer, and the adhesive force between the uniaxial alignment bodies, and exhibits the same effects as those of the first transparent net structure. The adhesive force between the uniaxial alignment bodies indicates the adhesive force between all uniaxial alignment bodies of the split web or slit web and one layer or two layers of the uniaxial alignment tape group layers, and this value also has the numerical characteristics in the range described in the section of the first transparent net structure. The tensile strength indicates the tensile strength in any one or both the alignment direction of the split web or slit web and the alignment direction of the uniaxial alignment tape group, and the value of the tensile strength is as described in the section of the first transparent net structure.

The transparent net structure according to the present embodiment is formed of a uniaxial alignment body of a multilayer film including a thermoplastic resin layer containing specific polypropylene (T) and an adhesive layer containing specific polypropylene (A). By employing a combination of the specific polypropylene (T) and the specific polypropylene (A), the transparency of the multilayer film can be enhanced, and the transparency of the transparent net structure can be enhanced more than in the related art.

### Second Embodiment: Reinforced Laminate

A second embodiment of the present invention relates to a reinforced laminate. The reinforced laminate is a reinforced laminate obtained by using the first to fourth transparent net structures or the transparent net structures according to the modified forms thereof as reinforcing materials and laminating these on a reinforced body. In a case of forming a reinforced laminate, the manufacturing cost can be reduced and the reinforced laminate can be applied to the reinforcement of various reinforced bodies because the mountability on a processing device and the processability and workability during the treatment with a machine for laminating the transparent net structure on the reinforced body can be improved. Examples of the reinforced material include synthetic resin films and sheets such as films and sheets, foamed films and sheets, and porous sheets, papers such as Japanese paper and kraft paper, and paperboards, metal foil such as rubber films and sheets, and aluminum foil, various kinds of nonwoven fabrics, for example, dry nonwoven fabrics such as melt blown nonwoven fabrics and spun lace nonwoven fabrics, and wet nonwoven fabrics such as pulp nonwoven fabrics, woven fabrics such as cloth, metals, pottery, and glass, but the present invention is not limited thereto.

Since the reinforced laminate according to the present embodiment has a high transparency, the reinforced laminate is particularly useful as a reinforcing material for a medical packaging material (sterile packaging material), a reinforcing material for a vegetable bag and food packaging, and a reinforcing material of a food filter such as a tea bag or a coffee filter.

### EXAMPLES

Next, the present invention will be described in more detail with reference to examples, but the present invention is not limited thereto. Further, each value in examples and comparative examples was acquired by the following methods.

### Test Examples 1 to 3 and Comparative Test Examples 1 to 7

A multilayer film was formed by laminating a resin listed in Table 1 used as a thermoplastic resin layer and a resin listed in Table 1 used as an adhesive layer by water-cooled inflation.

The haze of the formed multilayer film was measured in conformity with JIS K7136. The results are listed in Table 1. Further, the thickness of each multilayer film is also listed in Table 1.

TABLE 1

| | Resin | | | |
|---|---|---|---|---|
| | Thermoplastic | Adhesive | | Thick- |
| Configuration | resin layer | layer poly- | Haze | ness |
| of resin | polypropylene (T) | propylene (A) | (%) | (μm) |
| Comparative Test | (H)-1 | (R)-3 | 27.0 | 125 |
| Example 1 | | | | |
| Comparative Test | (II)-1 | (R)-1 | 16.0 | 125 |
| Example 2 | | | | |
| Test Example 1 | (B)-1 | (R)-1 | 4.0 | 125 |
| Comparative Test | (B)-2 | (R)-5 | 15.0 | 125 |
| Example 3 | | | | |
| Comparative Test | (R)-4 | (R)-5 | 17.0 | 125 |
| Example 4 | | | | |
| Test Example 2 | (R)-2 | (R)-1 | 5.0 | 125 |
| Comparative Test | (B)-1 | (R)-5 | 14.0 | 125 |
| Example 5 | | | | |
| Comparative Test | (B)-1 | (R)-3 | 8.0 | 125 |
| Example 6 | | | | |
| Comparative Test | (R)-2 | (R)-3 | 8.0 | 125 |
| Example 7 | | | | |
| Test Example 3 | (R)-4 | (R)-1 | 4.0 | 125 |

In Table 1, each abbreviation has the following meanings.

(B)-1: Block polypropylene (manufactured by SunAllomer Ltd.: CS356M)

(B)-2: Block polypropylene (manufactured by SunAllomer Ltd.: PF380A)

(R)-1: Metallocene catalyst-based random polypropylene (manufactured by Japan Polypropylene Corporation: WFX4TA)

(R)-2: Random polypropylene with metallocene catalyst (manufactured by Japan Polypropylene Corporation: WFW5T)

(R)-3: Random polypropylene (manufactured by Japan Polypropylene Corporation: FX4ET)

(R)-4: Random polypropylene (manufactured by SunAllomer Ltd.: PB222A)

(R)-5: Random polypropylene (Sumitomo Chemical Co., Ltd.: S131)

(H)-1: Homopropylene (manufactured by SunAllomer Ltd.: PL400A)

The melt flow rate (g/10 min), the density (g/cm³), and the melting point (° C.) of each resin are listed in Table 2.

TABLE 2

| | MFR | Density | Melting point |
|---|---|---|---|
| Resin | (g/10 min) | (g/cm³) | (° C.) |
| (B)-1 | 2 | 0.9 | 152 |
| (B)-2 | 1.2 | 0.9 | 163 |
| (R)-1 | 7 | 0.9 | 125 |
| (R)-2 | 3.5 | 0.9 | 145 |
| (R)-3 | 5.3 | 0.9 | 132 |
| (R)-4 | 0.8 | 0.9 | 152 |
| (R)-5 | 1.5 | 0.9 | 132 |
| (II)-1 | 2 | 0.9 | 163 |

As listed in Table 1, it was confirmed that the multilayer film of Test Example 1 had a reduced haze as compared with the multilayer films of Comparative Test Examples 5 and 6 in which the thermoplastic resin layers (polypropylene (T)) were the same.

Further, it was also confirmed that the multilayer film of Test Example 1 had a reduced haze as compared with the multilayer film of Comparative Test Example 2 in which the adhesive layers (polypropylene (A)) were the same.

Further, it was also confirmed that the multilayer film of Test Example 1 had a reduced haze as compared with the multilayer films of Comparative Test Examples 1, 3, 4 and 7.

It was confirmed that the multilayer film of Test Example 2 had a reduced haze as compared with the multilayer film of Comparative Test Example 7 in which the thermoplastic resin layers (polypropylene (T)) were the same.

Further, it was also confirmed that the multilayer film of Test Example 2 had a reduced haze as compared with the multilayer film of Comparative Test Example 2 in which the adhesive layers (polypropylene (A)) were the same.

Further, it was also confirmed that the multilayer film of Test Example 2 had a reduced haze as compared with the multilayer films of Comparative Test Examples 1 and 3 to 6.

It was confirmed that the multilayer film of Test Example 3 had a reduced haze as compared with the multilayer film of Comparative Test Example 4 in which the thermoplastic resin layers (polypropylene (T)) were the same.

Further, it was also confirmed that the multilayer film of Test Example 3 had a reduced haze as compared with the multilayer film of Comparative Test Example 2 in which the adhesive layers (polypropylene (A)) were the same.

Further, it was also confirmed that the multilayer film of Test Example 3 had a reduced haze as compared with the multilayer films of Comparative Test Examples 1, 3 to 7.

Therefore, it is expected that the transparent net structures obtained by weaving the uniaxial alignment bodies formed of the multilayer films of Test Examples 1 to 3 have a high transparency.

Hereinbefore, the preferred examples of the present invention have been described, but the present invention is not limited to these examples. Additions, omissions, replacements, and modifications of configurations can be made in a range without departing from the gist of the present invention. The present invention is not limited by the foregoing description, but is limited only by the scope of the appended claims.

### EXPLANATION OF REFERENCES

1 Net nonwoven fabric
2 Split web (net film)
21 Stem fiber
22 Branch fiber
2-1 Vertical web
2-2 Horizontal web
3 Slit web
6, 6′ Thermoplastic resin layer (net film)
7-1, 7-1′ Metallocene PP layer (adhesive layer)
7-2, 7-2′ Metallocene PP layer (adhesive layer)
L, T Alignment axis

1. A transparent net structure comprising:
two or more uniaxial alignment bodies of a multilayer film which includes a thermoplastic resin layer containing at least one polypropylene (T) selected from the group consisting of block polypropylene and random polypropylene polymerized with a metallocene catalyst, and
an adhesive layer containing polypropylene (A) polymerized with a metallocene catalyst and laminated on at least one surface of the thermoplastic resin layer,
wherein the two or more uniaxial alignment bodies are laminated or woven such that the adhesive layers are interposed among the two or more uniaxial alignment bodies and alignment axes of the two or more uniaxial alignment bodies intersect with each other.

2. The transparent net structure according to claim 1,
wherein a melt flow rate of the polypropylene (A) is higher than a melt flow rate of the polypropylene (T).

3. The transparent net structure according to claim 2,
wherein the melt flow rate of the polypropylene (A) is in a range of 1 to 10 g/10 min.

4. The transparent net structure according to claim 1,
wherein a melting point of the polypropylene (A) is lower than a melting point of the polypropylene (T) by 5° C. or higher.

5. The transparent net structure according to claim 1,
wherein the polypropylene (A) is random polypropylene polymerized with a metallocene catalyst.

6. The transparent net structure according to claim 1,
wherein the uniaxial alignment body is produced by uniaxially stretching a multilayer film obtained by inflation molding.

7. The transparent net structure according to claim 1,
wherein a haze of the multilayer film which is measured in conformity with JIS K7136 is less than 8%.

8. The transparent net structure according to claim 1,
wherein the haze of the multilayer film which is measured in conformity with JIS K7136 is less than 6%.

9. The transparent net structure according to claim 1,
wherein the two or more uniaxial alignment bodies are at least one of uniaxial alignment net films or uniaxial alignment tapes.
